(19) United States
(12) Patent Application Publication
(10) Pub. No.: US 2012/0290388 A1
(43) Pub. Date: Nov. 15, 2012

(54) SYSTEM AND METHOD FOR COMPLETING AN ONLINE TRANSACTION REQUEST ON A NETWORK DEVICE

(75) Inventor: Carissa Ganelli, Old Greenwich, CT (US)

(73) Assignee: Carissa Ganelli, Old Greenwich, CT (US)

(21) Appl. No.: 13/471,442

(22) Filed: May 14, 2012

Related U.S. Application Data
(60) Provisional application No. 61/486,243, filed on May 14, 2011.

(51) Int. Cl. G06Q 20/38; G06Q 20/40; G06Q 30/02

(52) U.S. Cl. 705/14.51; 705/39; 705/44

(57) ABSTRACT

A method for completing an online transaction request on a network device is disclosed. The method includes collecting transaction information and providing a visible transaction window interface on a network device. The method also includes providing transaction information in the visible transaction window interface. The method further includes initiating an online transaction request from the visible transaction window interface and determining whether the request was successful. The method also includes providing notice as to the results of the transaction request.

### CROSS-REFERENCE TO RELATED PATENTS

This application claims the benefit of Provisional Patent Application, Application No. 61/486,243, filed 14 May 2011 by the present inventor, which is incorporated by reference.

### FIELD OF ART

The present invention generally relates to electronic transactions. More particularly, the invention relates to methods for completing transaction requests using network devices.

### PRIOR ART

The following is a list of some prior art that presently appears relevant:

| Pat. No. | Issue Date | Patentee |
|---|---|---|
| 7,992,773 | 2011 | Rothschild |
| 7,848,980 | 2010 | Carlson |
| 7,848,500 | 2010 | Lynam et al. |
| 7,788,143 | 2010 | Gindlesperger |
| 7,729,994 | 2010 | Gupta et al. |
| 7,720,762 | 2010 | Rolf |
| 7,617,972 | 2009 | Hogg et al. |
| 7,617,121 | 2009 | DeMayo et al. |
| 7,437,368 | 2008 | Kolluri et al. |
| 7,333,953 | 2008 | Banaugh et al. |
| 7,324,976 | 2008 | Gupta et al. |
| 7,058,598 | 2006 | Chen et al. |
| 6,879,691 | 2005 | Koretz |

| Publication Number | Publ. Date | Applicant |
|---|---|---|
| 20110066517 | 2011 | Smith et al. |
| 20110047045 | 2011 | Brody et al. |
| 20110035318 | 2011 | Hargrove et al. |
| 20110010631 | 2011 | Rothschild |
| 20110010293 | 2011 | Giordano et al. |
| 20110010292 | 2011 | Giordano et al. |
| 20110004547 | 2011 | Giordano et al. |
| 20100293065 | 2010 | Brody et al. |
| 20100280910 | 2010 | Hogg et al. |
| 20100082444 | 2010 | Lin et al. |
| 20100023878 | 2010 | Douris et al. |
| 20100010908 | 2010 | Pasupulati et al. |
| 20090288012 | 2009 | Hertel et al. |
| 20090240594 | 2009 | Kerner et al. |
| 20090192911 | 2009 | Graf |
| 20080072067 | 2008 | Koretz et al. |
| 20080098000 | 2008 | Koretz et al. |
| 20080195506 | 2008 | Koretz |
| 20070287413 | 2007 | Kleitsch et al. |

### BACKGROUND

Electronic payment transactions are now routinely conducted online by people and machines using the Internet or other broadband communications networks. Yet today users are beginning to migrate this online transaction behavior to mobile devices. Many companies, particularly banks, online retailers, and mobile application developers have devised methods to allow users to initiate a payment transaction from a mobile device.

Virtually all payment transactions on mobile devices currently fall into five categories: 1) vendor-specific software “shopping cart” checkout systems such as Amazon.com that require users to input their contact and payment information in a web browser or an application interface prior to each purchase, 2) add-on hardware attachments such as those made by Square designed to connect to a mobile device and read a traditional user-provided magnetic stripe credit card or similar card form of payment while connected to a service such as Square, 3) alternate payment services such as PayPal that require a user to create an account, and for each transaction, provide account login credentials through a vendor's interface or the payment service's application or website, 4) services such as BOKU that allow users to charge their postpaid mobile device accounts for non-mobile service purchases, and 5) mobile wallet systems utilizing Near Field Communications (NFC) semiconductor chips, SIM cards, or other methods that allow communication between a mobile device and an external reader or kiosk to facilitate a payment through traditional payment avenues such as Visa and Mastercard or alternative services like PayPal.

Unfortunately for users, these methods were not designed and did not contemplate users making contextual purchases within the same user interface they were already using. These methods do not allow a user to complete a transaction while using a contextual interface not tied to an existing vendor or payment account. For example, none of these methods allow a user to complete the purchase of a highlighted item within the body of an online article after selecting from a choice of vendor, price, and shipping options without leaving the online article interface or logging in as an authorized user to a preexisting payment system on that preexisting payment system's website or application.

Thus what is needed to keep pace with the migration of commerce to mobile devices and evolving user shopping patterns is a method for allowing networked users to complete a contextual payment transaction while leveraging their existing payment accounts from any location and without creating a new merchant or personal account. This transaction would be based on contextual vendor, item, pricing, shipping, and other information all available from within a simple overlay user interface in a secure and reliable fashion. The present invention addresses this need for a faster, more robust, and contextually-aware mobile transaction method and system.

### SUMMARY OF THE INVENTION

Embodiments of the present invention comprise methods and systems for completing an online transaction request on a network device. In one embodiment, a user uses her mobile Internet browser on her mobile network device to read an article at an online location, such as a website. Within that article, she reads about a new toy that she wants to buy and selects a picture of the toy using the tools of her browser and mobile network device. The online location interacts with the present invention and the mobile network device to provide a prompt. The user touches the screen of her device to activate the prompt, after which a visible transaction window interface related to purchasing the toy is provided. The user then reviews the transaction information in the visible transaction windows interface, and decides to buy the toy at a given price from a vendor identified in the presented transaction information. She activates the contextual prompt given to initiate the transaction request. The transaction request is initiated and a confirmation is provided when the transaction request is completed.

In one embodiment, the user is provided with the contextual prompts and transaction window interface from within an application. In another embodiment, neither a browser nor an application is used to implement the method; it is the combination of the hardware and software of the actual mobile network device that provides the contextual prompts, transaction window interface, transaction information, and transaction request.

These exemplary embodiments are mentioned not to limit or define the invention, but to provide examples of embodiments of the invention to aid understanding thereof. Exemplary embodiments are discussed in the detailed description and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following detailed description is read with reference to the accompanying drawings, wherein:

FIG. 1 is a schematic illustrating an exemplary network environment in which one embodiment of the present invention may operate;

FIG. 2 is a diagram illustrating a representative network device screen with a contextual prompt in which one embodiment of the present invention may operate;

FIG. 3A illustrates a flow diagram of a method for completing a pending online transaction request on a network device in accordance with one embodiment of the present invention;

FIG. 3B illustrates a flow diagram of a method for completing a pending online transaction request on a network device and providing a contextual prompt prior to collecting transaction information related to a pending online transaction whose acknowledgement initiates collecting transaction information related to a pending online transaction in accordance with one embodiment of the present invention;

FIG. 3C illustrates a flow diagram of a method for completing a pending online transaction request on a network device and storing collected transaction information in accordance with one embodiment of the present invention;

FIG. 3D illustrates a flow diagram of a method for completing a pending online transaction request on a network device wherein the step of collecting additional prompted transaction information related to a pending online transaction is further refined to basing the prompting for additional transaction information on transaction information already collected related to a pending online transaction in accordance with one embodiment of the present invention;

FIG. 3E illustrates a flow diagram of a method for completing a pending online transaction request on a network device and further comprising the step of providing a contextual prompt that once acknowledged initiates the action of cancelling the transmission of transaction information related to a pending online transaction to a transaction services provider in accordance with one embodiment of the present invention;

FIG. 3F illustrates a flow diagram of a method for completing a pending online transaction request on a network device and further comprising the step of displaying promotional information in the visible transaction window interface based on collected transaction information in accordance with one embodiment of the present invention;

FIG. 3G illustrates a flow diagram of a method for completing a pending online transaction request on a network device and displaying promotional information in the visible transaction window interface based on collected transaction information and further comprising the step of initiating an online transaction related to the displayed promotional information shown in the visible transaction window interface in accordance with one embodiment of the present invention;

FIG. 3H illustrates a flow diagram of a method for completing a pending online transaction request on a network device and further comprising the step of determining whether the transmission of transaction information related to a pending online transaction to a transaction services provider was successful in accordance with one embodiment of the present invention;

FIG. 3I illustrates a flow diagram of a method for completing a pending online transaction request on a network device and determining whether the transmission of transaction information related to a pending online transaction to a transaction services provider was successful and further comprising the step of displaying the results of the determination as to whether the transmission of transaction information related to a pending online transaction to a transaction services provider was successful in a transaction window interface in accordance with one embodiment of the present invention;

FIG. 4A illustrates a flow diagram of a method for completing a pending online transaction request on a network device in accordance with one embodiment of the present invention;

FIG. 4B illustrates a flow diagram of a method for completing a pending online payment request on a network device and providing a contextual prompt prior to collecting transaction information related to a pending online transaction whose acknowledgement initiates collecting transaction information related to a pending online transaction in accordance with one embodiment of the present invention;

FIG. 4C illustrates a flow diagram of a method for completing a pending online payment request on a network device and storing collected transaction information in accordance with one embodiment of the present invention;

FIG. 4D illustrates a flow diagram of a method for completing a pending online payment request on a network device wherein the step of collecting additional prompted transaction information related to a pending online transaction is further refined to basing the prompting for additional transaction information on transaction information already collected related to a pending online transaction in accordance with one embodiment of the present invention;

FIG. 4E illustrates a flow diagram of a method for completing a pending online payment request on a network device and further comprising the step of providing a contextual prompt that once acknowledged initiates the action of cancelling the transmission of transaction information related to a pending online transaction to a transaction services provider in accordance with one embodiment of the present invention;

FIG. 4F illustrates a flow diagram of a method for completing a pending online payment request on a network device and further comprising the step of displaying promotional information in the visible transaction window interface based on collected transaction information in accordance with one embodiment of the present invention;

FIG. 4G illustrates a flow diagram of a method for completing a pending online payment request on a network device and displaying promotional information in the visible transaction window interface based on collected transaction information and further comprising the step of initiating an online transaction related to the displayed promotional information shown in the visible transaction window interface in accordance with one embodiment of the present invention;

FIG. 4H illustrates a flow diagram of a method for completing a pending online payment request on a network device and further comprising the step of determining whether the transmission of transaction information related to a pending online transaction to a transaction services provider was successful in accordance with one embodiment of the present invention;

FIG. 4I illustrates a flow diagram of a method for completing a pending online payment request on a network device and determining whether the transmission of transaction information related to a pending online transaction to a transaction services provider was successful and further comprising the step of displaying the results of the determination as to whether the transmission of transaction information related to a pending online transaction to a transaction services provider was successful in a transaction window interface in accordance with one embodiment of the present invention;

FIG. 4J illustrates a flow diagram of a method for completing a pending online payment request on a network device and further comprising the step of determining whether the transmission of transaction information related to a pending online payment to a transaction services provider resulted in successful approval of that online payment in accordance with one embodiment of the present invention;

FIG. 4K illustrates a flow diagram of a method for completing a pending online payment request on a network device and determining whether the transmission of transaction information related to a pending online payment to a transaction services provider resulted in successful approval of that online payment and further comprising the step of displaying the results of the determination as to whether the transmission of transaction information related to a pending online payment to a transaction services provider resulted in successful approval of that online payment in a transaction window interface in accordance with one embodiment of the present invention;

### DETAILED DESCRIPTION OF EMBODIMENTS

The present invention provides methods for completing a transaction request on a network device.

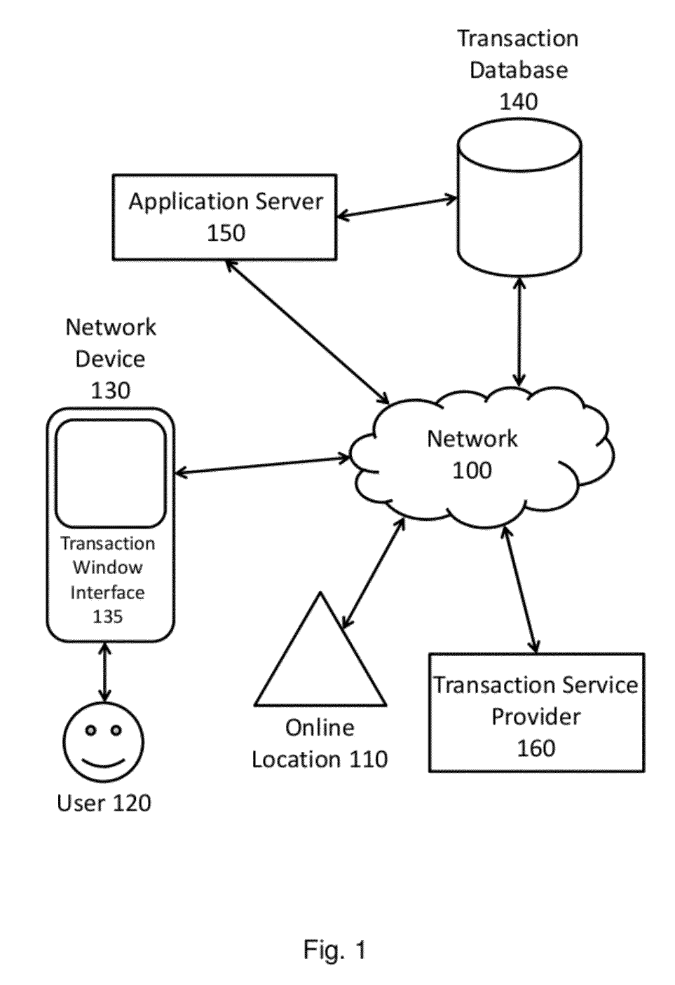

FIG. 1 is a schematic illustrating an exemplary logical environment in which one embodiment of the present invention may operate. Network 100 provides network access to the other elements of the environment. The network access may be wired or wireless, and may connect to the Internet or some other type of network. A network may be part of a larger network that provides network access to the elements of the environment.

Online Location 110 may be a website, an intranet location, a network computer, a network software program, or some other network access mechanism. User 120 can access the Online Location 110 using their Network Device 130 that is connected to Network 100. User 120 can be a person or a computer program. Network Device 130 can be a computer, a mobile phone, a handheld tablet device, or any other network device capable of accessing Online Location 110 through Network 100.

Transaction Window Interface 135 is a visual interface found on the screen of Network Device 130. It may take up some or all of the visible screen space on Network Device 130. It contains dynamic content that may change over the course of a potential transaction. It is connected to Network 100 and its contents may be generated from transaction information collected from Network Device 130, Network 100, or any of the network elements connected to Network 100 such as Online Location 110, Application Server 150, Transaction Database 140, or Transaction Service Provider 160.

Transaction Database 140 is a database containing transaction information accessible by other network elements through Network 100. Transaction information may include but is not limited to unique identifiers of specific instances of Online Location 110, User 120, Network Device 130, Transaction Service Provider 160, as well as detailed transaction information such as physical or logical items involved in an online transaction such as an item's price, color, size, type, availability, location, or any other distinguishing characteristic relevant to an online transaction. Additional transaction information may include but is not limited to payment information, frequency and duration related to one or more of a series of related online transactions, promotional material related to a transaction, and time-sensitive information unique to a particular transaction or type of transaction. Access to Transaction Database 140 is controlled by Application Server 150 and other permissions as authorized by Application Server 150.

Application Server 150 is a computer server connected to Network 100 and Transaction Database 140. Application Server 150 contains hardware and software elements and is designed to effect an online transaction based on collected transaction information generated from Network 100, Online Location 110, User 120, Network Device 130, Transaction Window Interface 135, Transaction Database 140, and Transaction Service Provider 160.

Transaction Service Provider 160 is responsible for any transaction associated with Network Device 130 using Transaction Window Interface 135 and Network 100. Transaction Service Provider 160 may provide processing, payment, notification, receipt, delivery, authentication, authorization, or any other service necessary to effect an online transaction. Transaction Service Provider 160 could be a bank, a payment authorization company, a third party reseller, a telecommunications service provider, or any other entity impacting an online transaction.

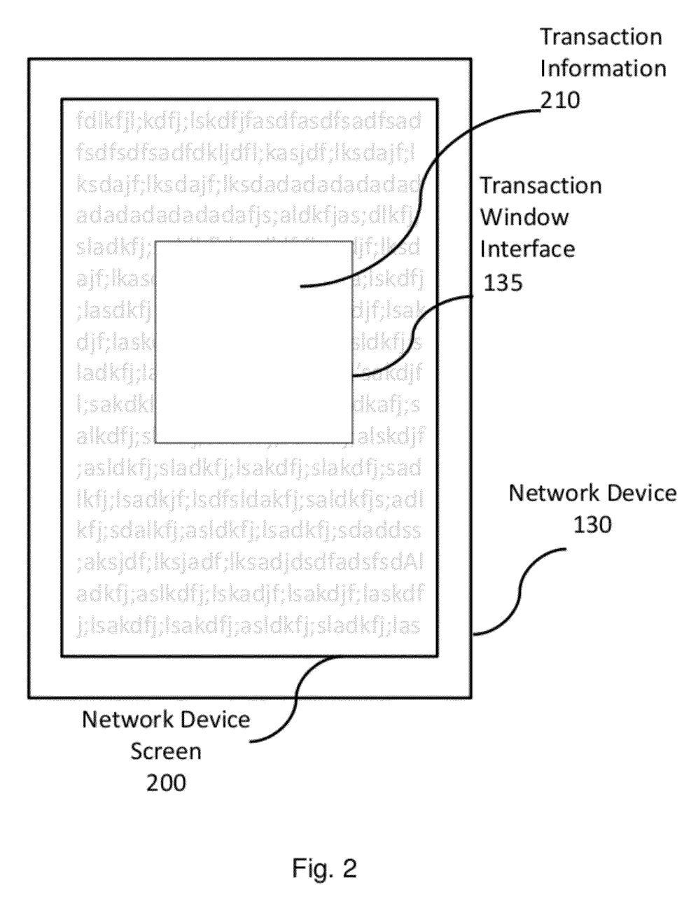

FIG. 2 is diagram illustrating a representative network device screen containing Transaction Window Interface 135. Network Device 130 contains Network Device Screen 200. Network Device Screen 200 contains Transaction Window Interface 135. Transaction Window Interface 135 contains Transaction Information 210.

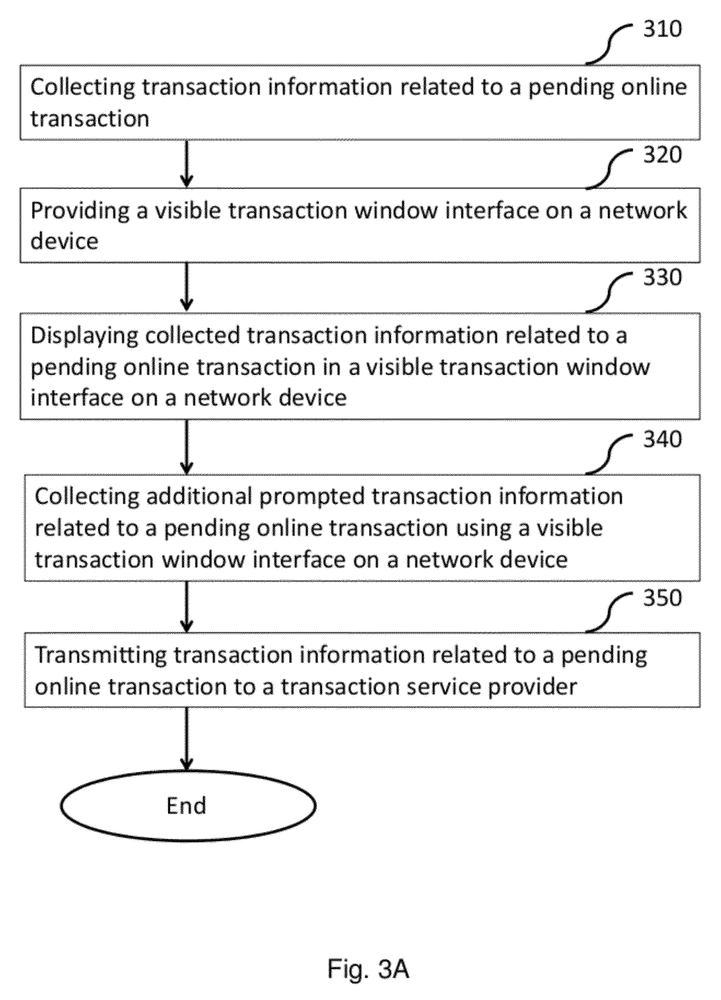

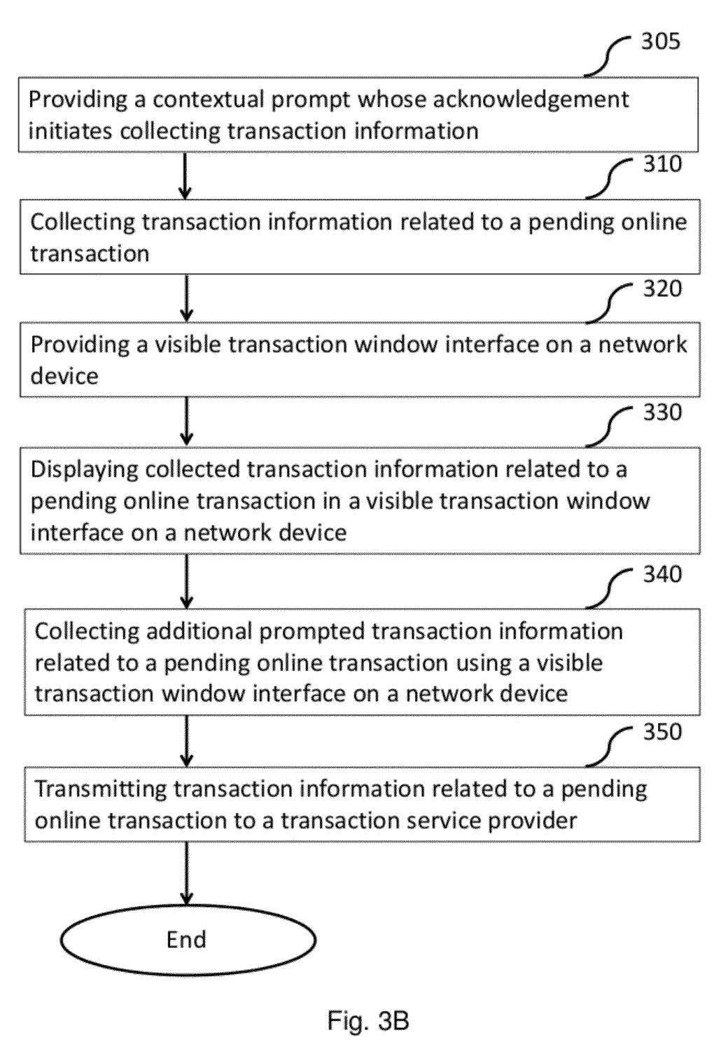

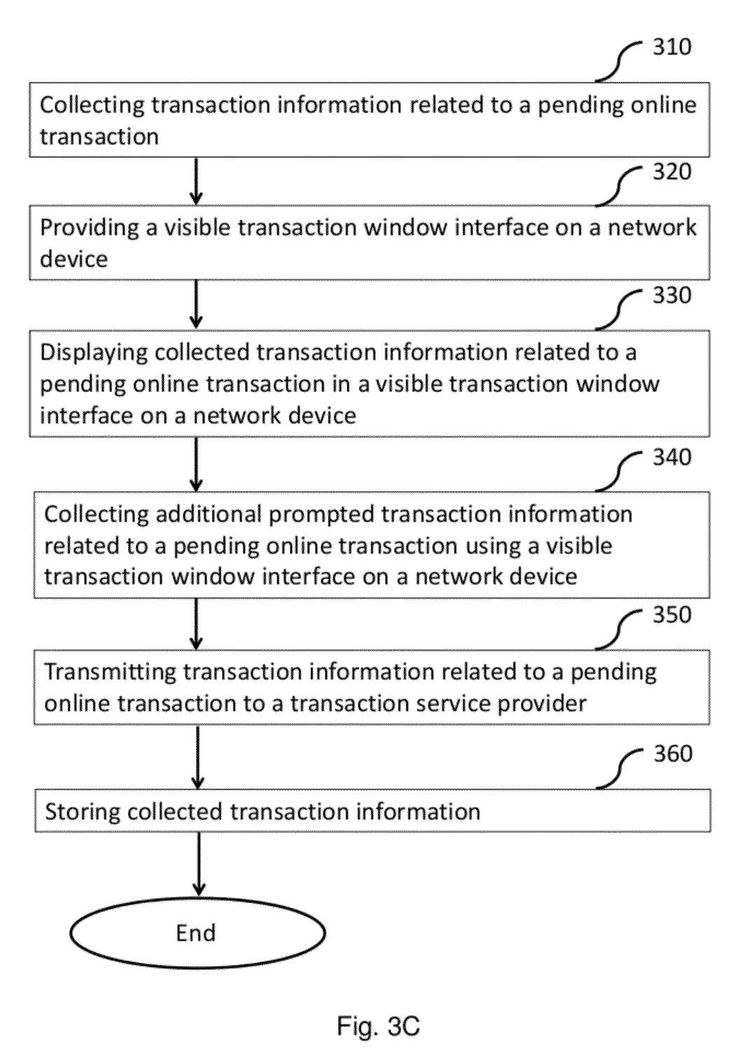

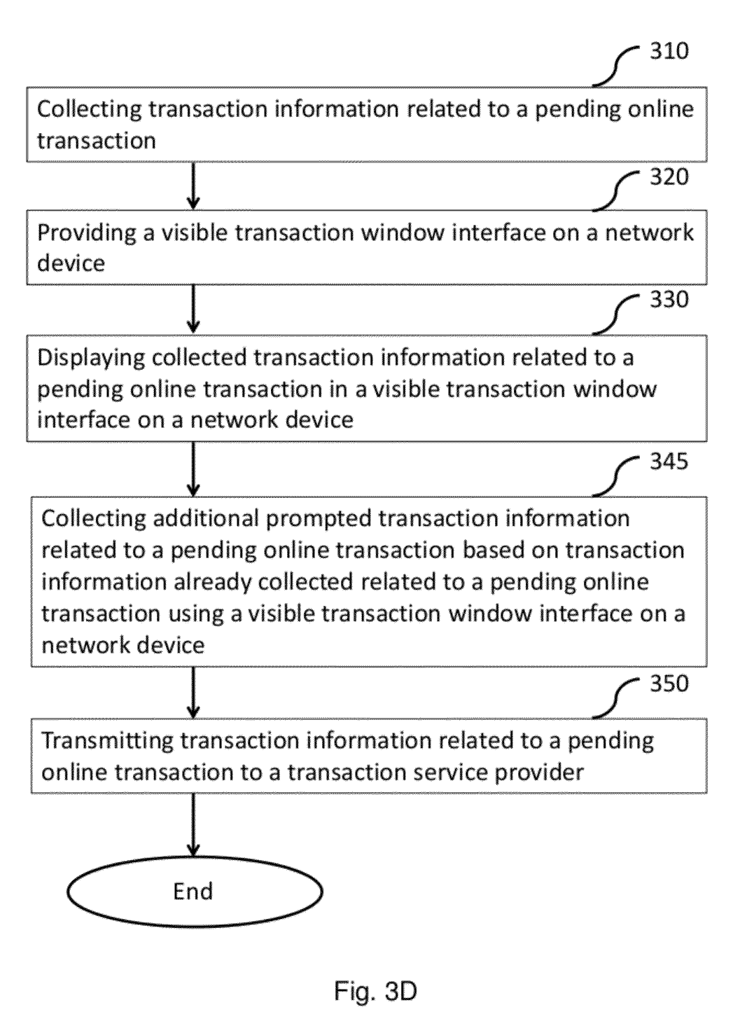

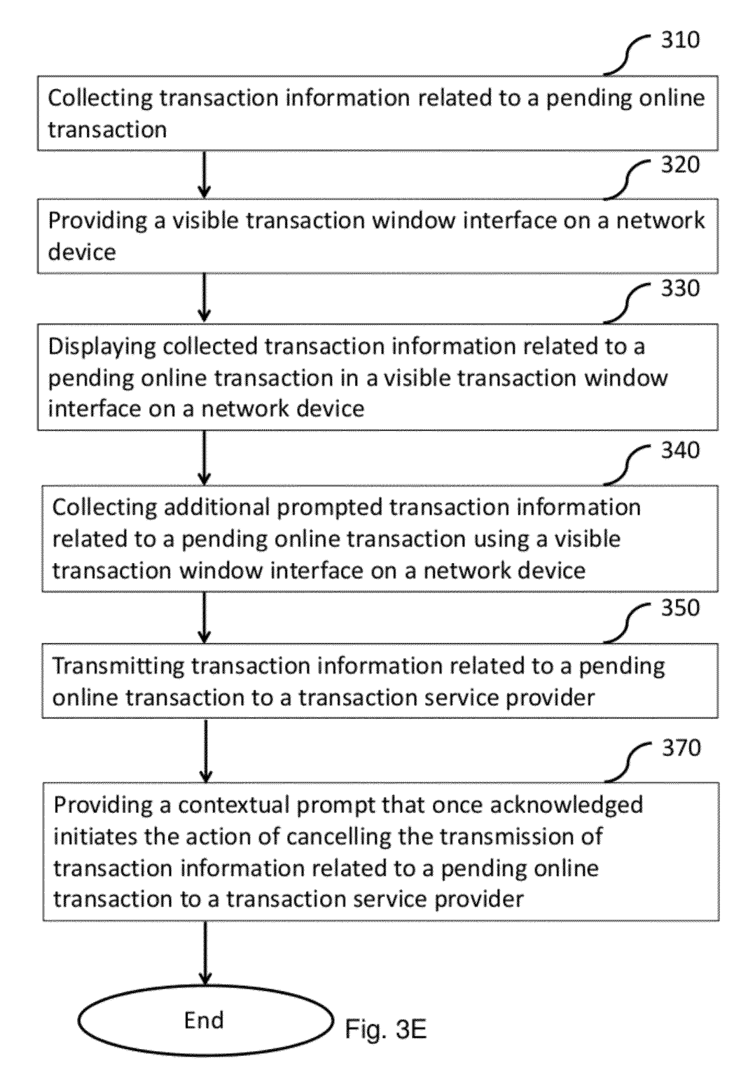

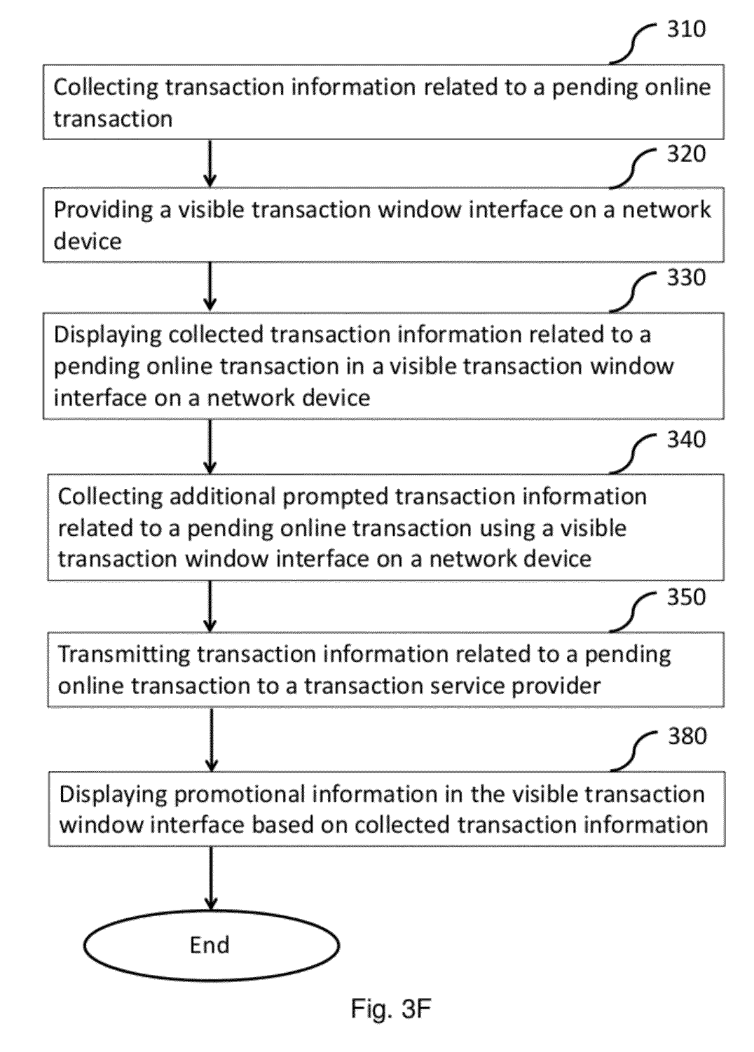

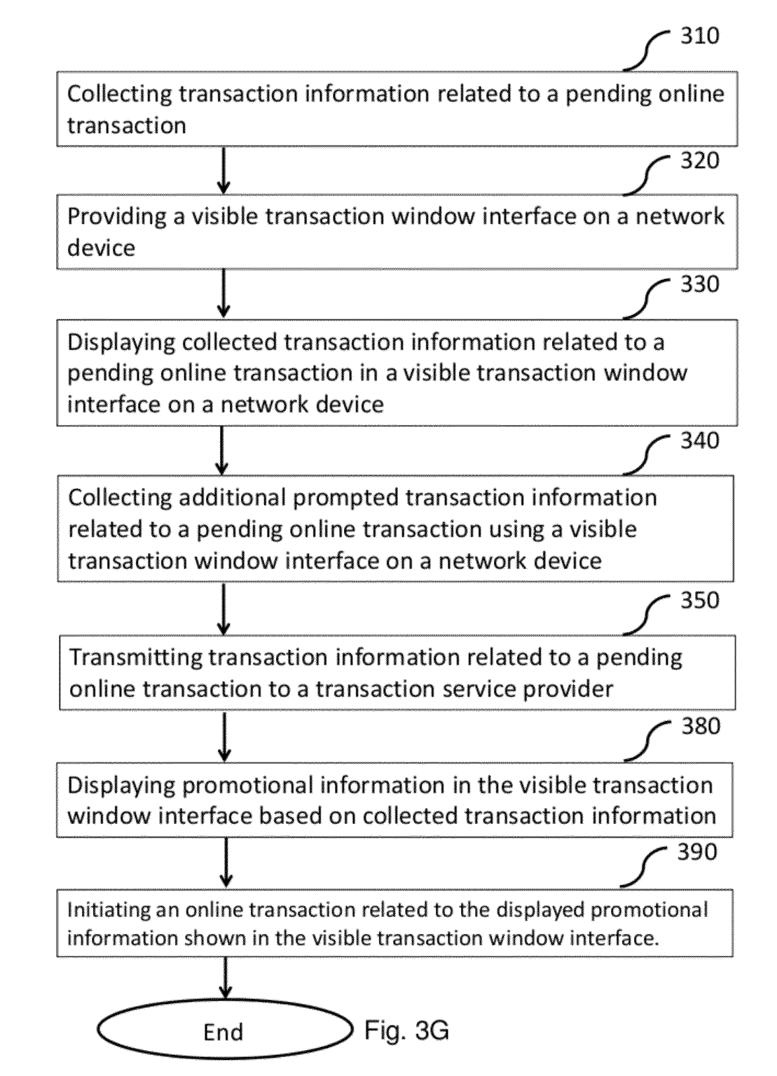

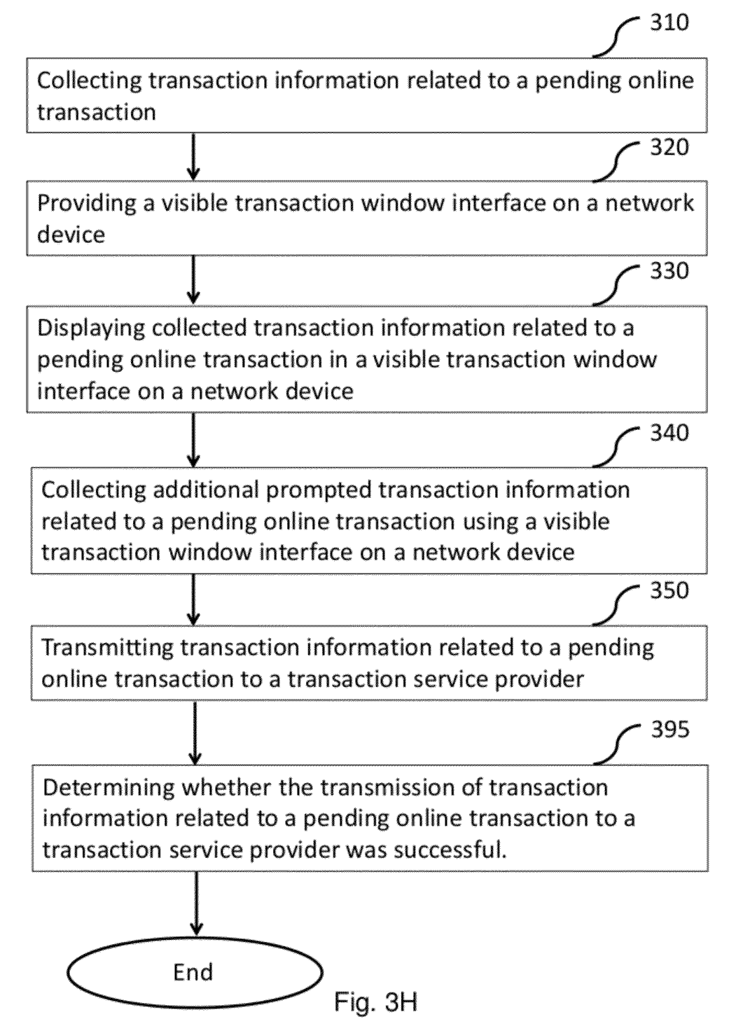

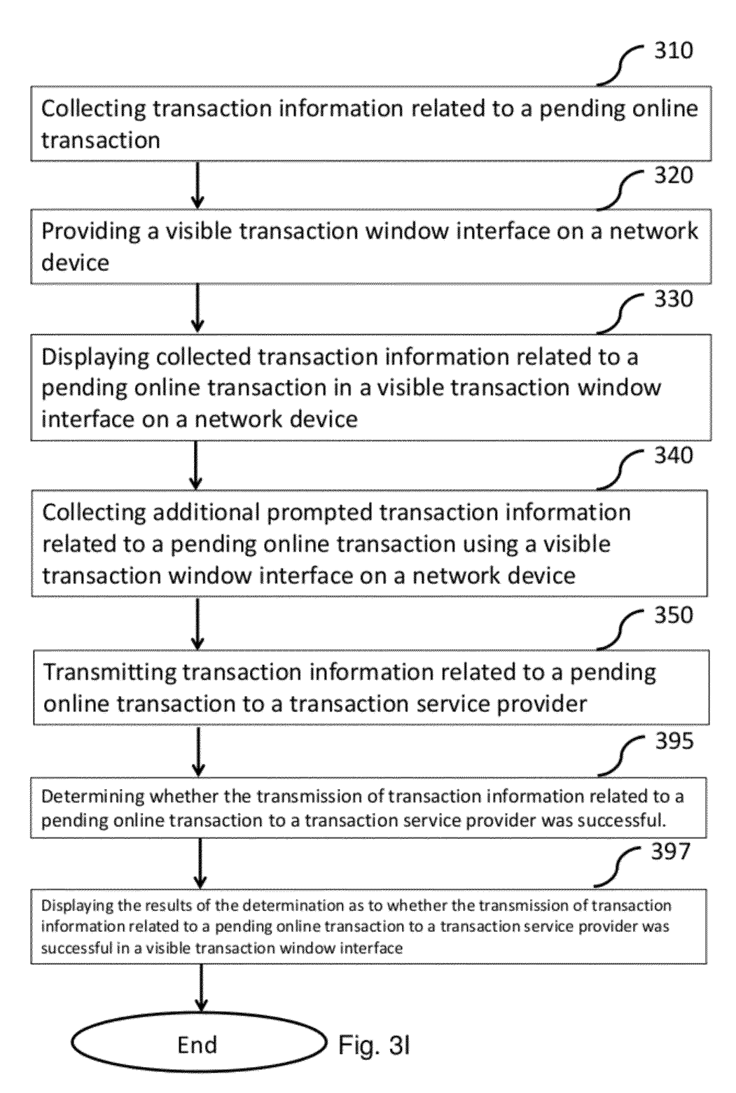

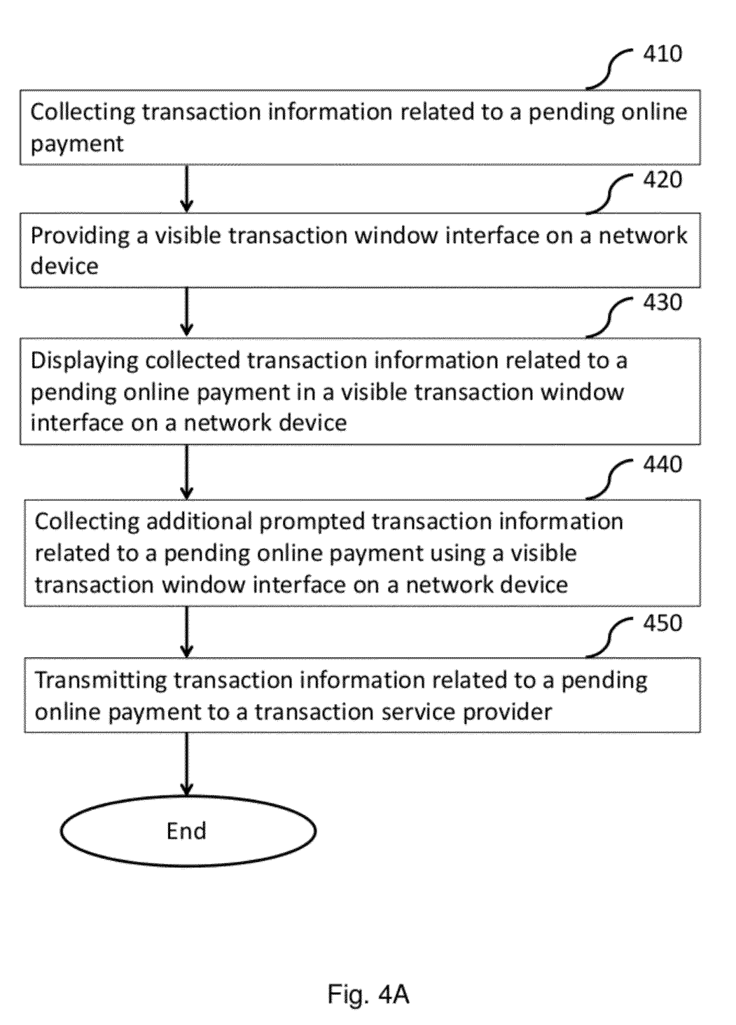

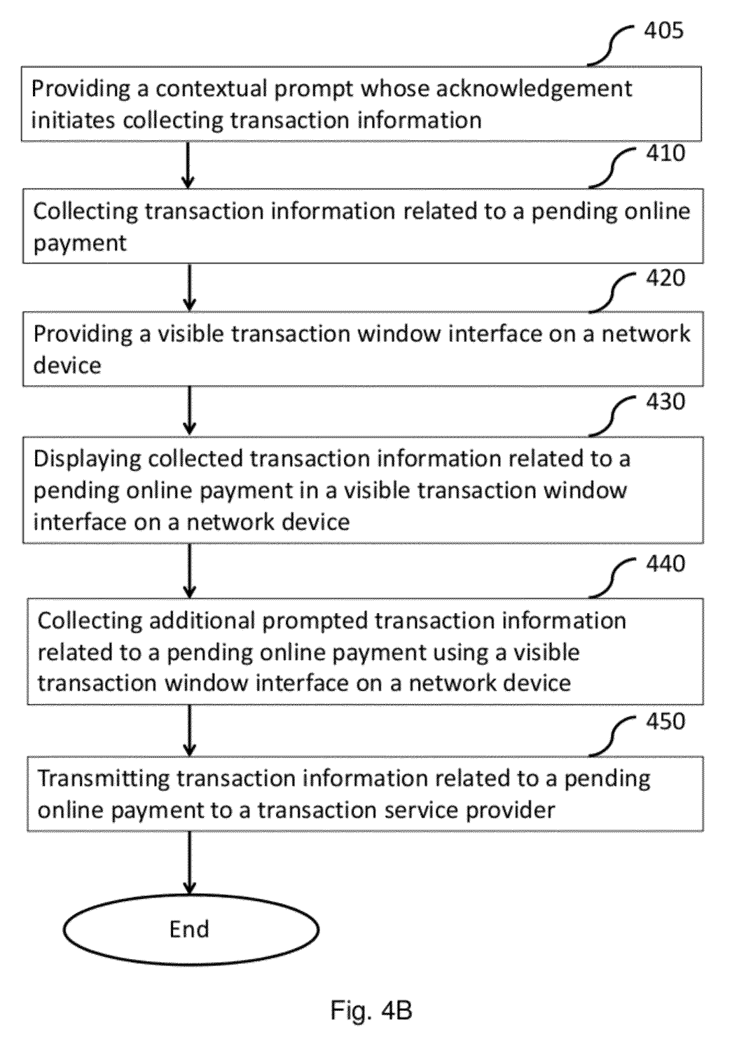

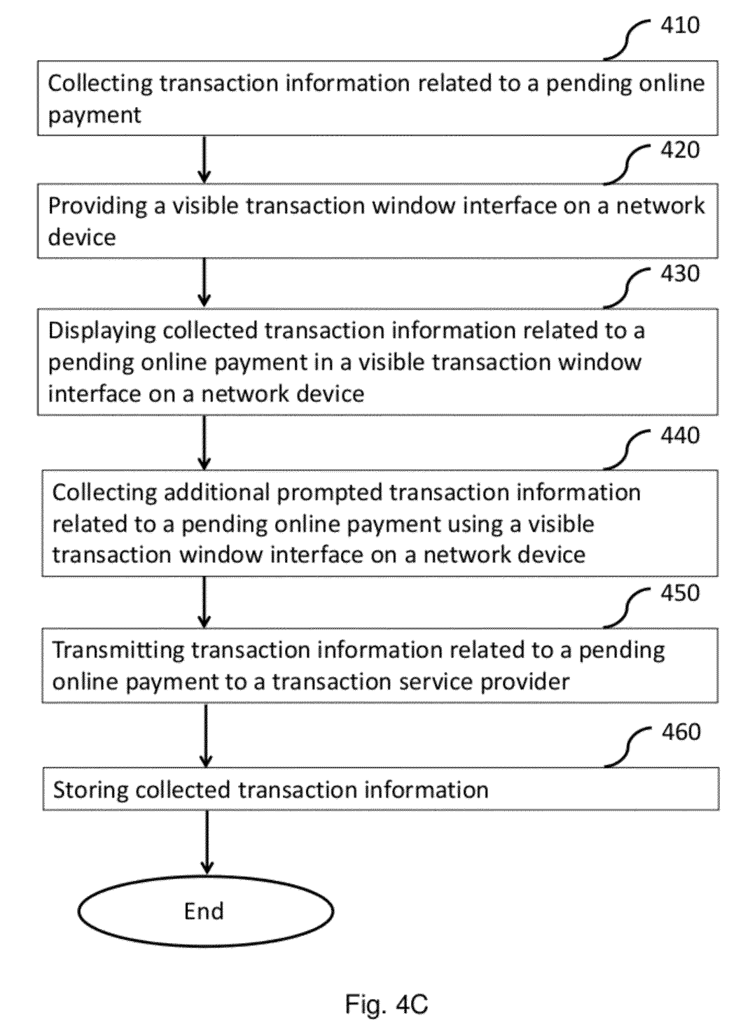

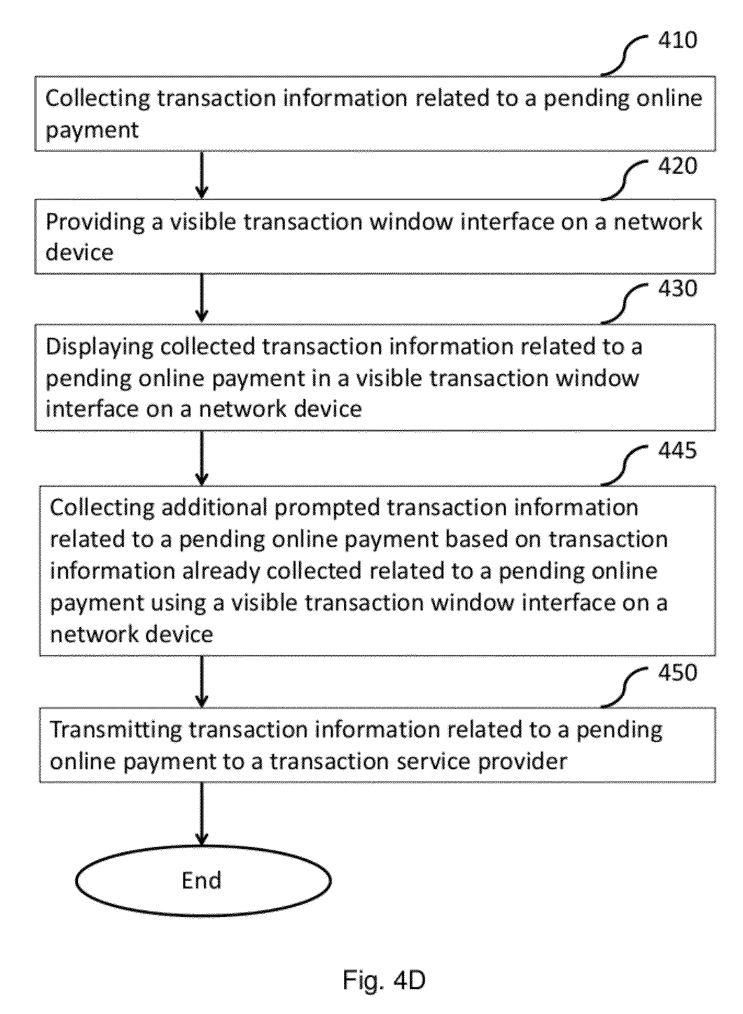

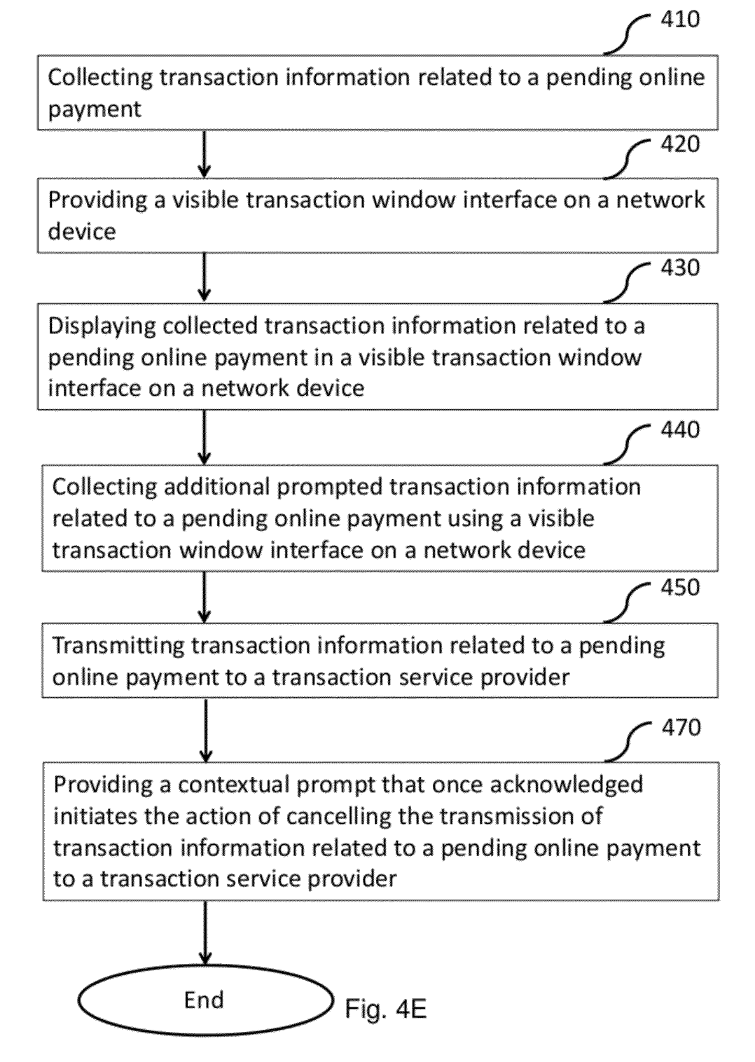

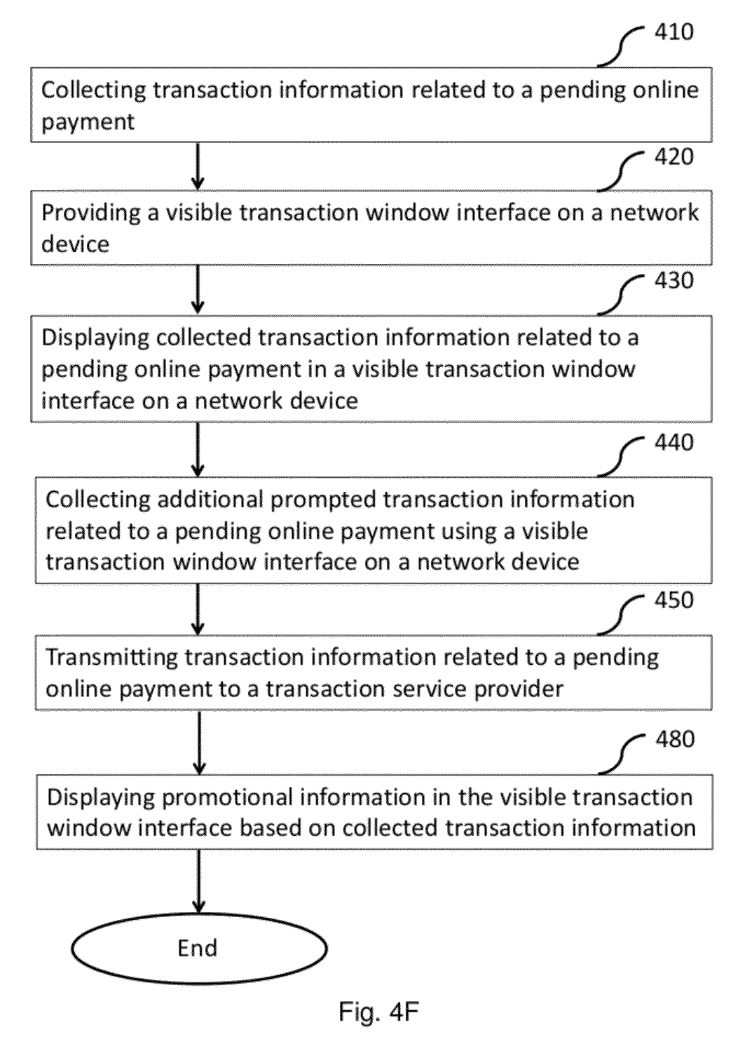

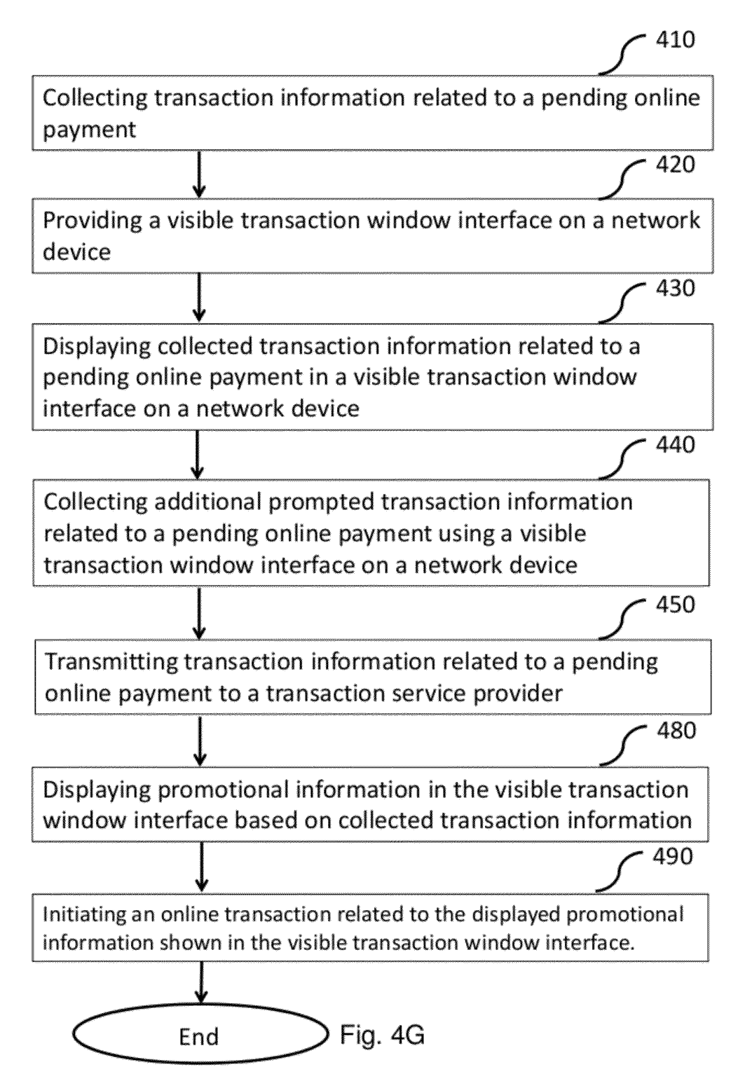

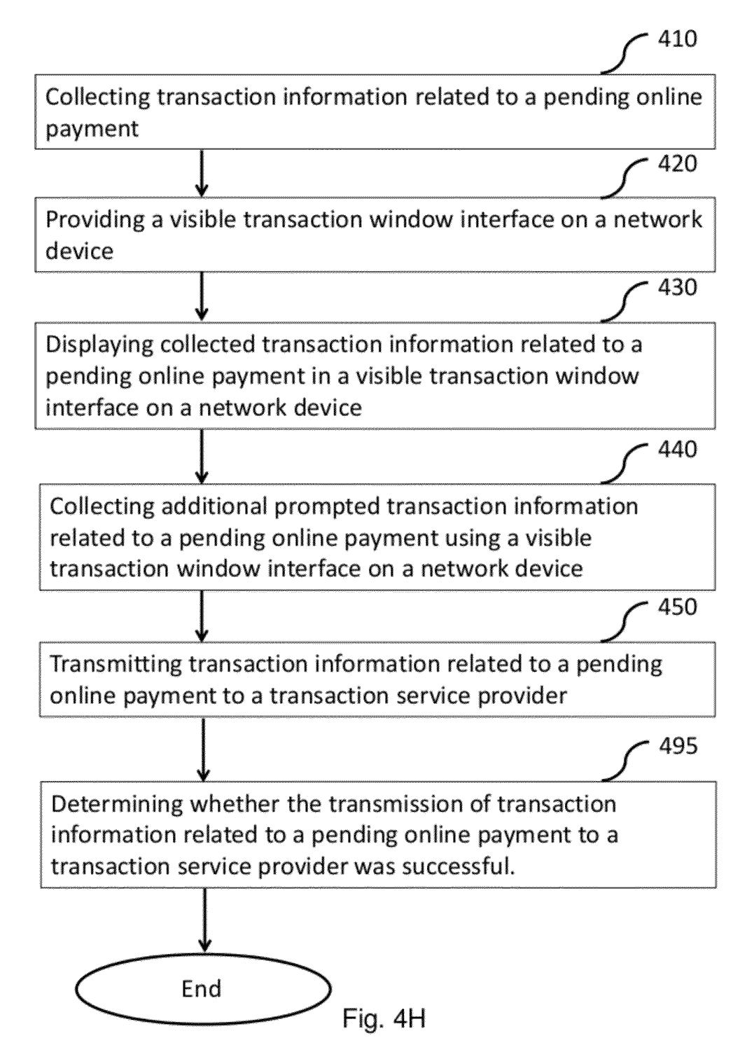

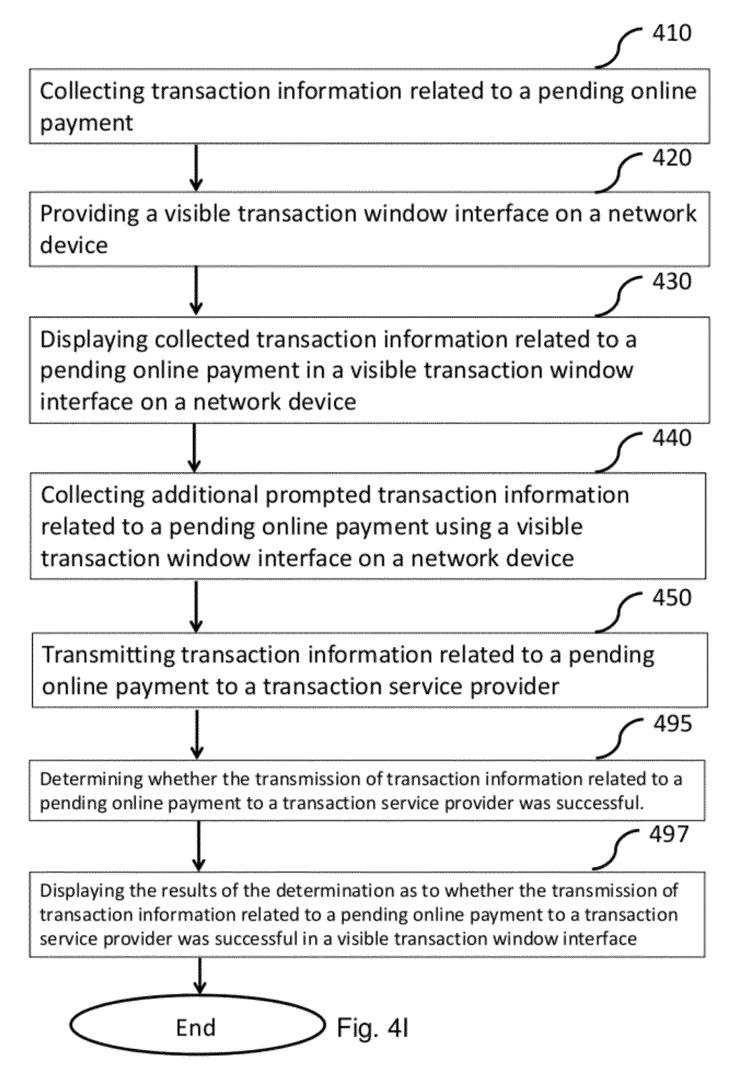

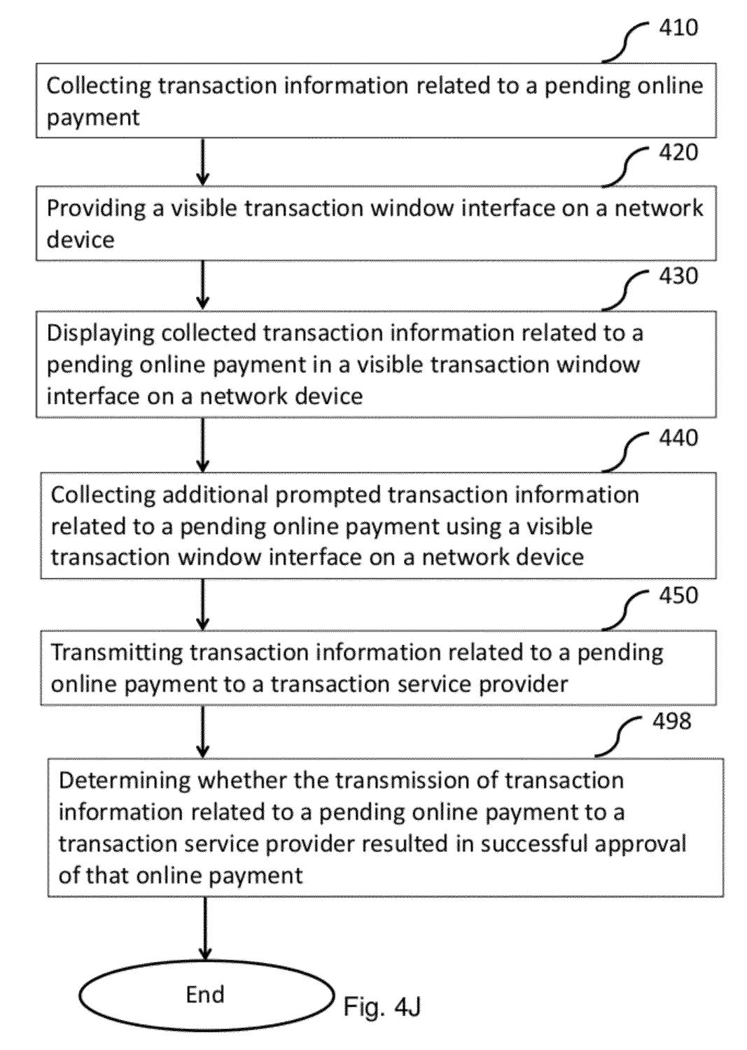

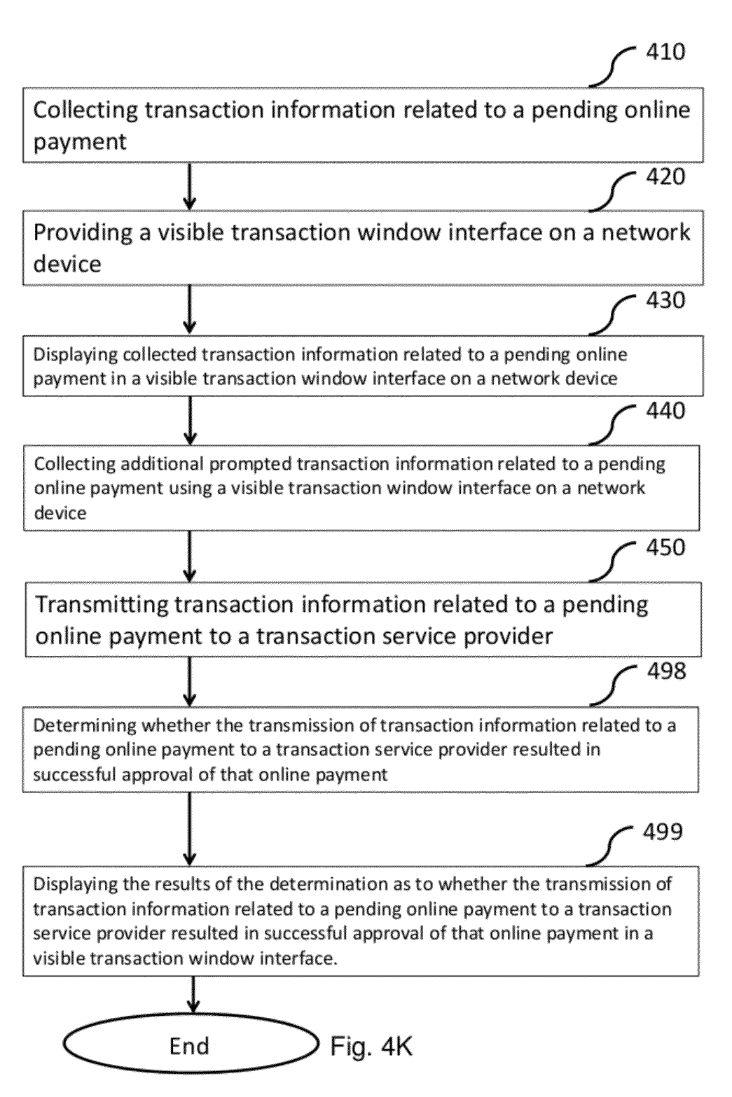

FIGS. 3A, 3B, 3C, 3D, 3E, 3F, 3G, 3H, and 3I are flow diagrams illustrating a method for completing a pending online transaction request on a network device. FIGS. 4A, 4B, 4C, 4D, 4E, 4F, 4G, 4H, and 4I are flow diagrams illustrating a method for completing a pending online payment request on a network device. It should be noted that the above-described embodiments of the present invention are merely possible examples of implementations set forth for a clear understanding of the principles of the invention. Many variations and modifications may be made to the above-described embodiments of the invention without departing substantially from the spirit and principles of the invention. All such variations and modifications are intended to be included within the scope of this disclosure and the present invention and protected by the following claims.

FIG. 3A is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160.

FIG. 3B is a flow diagram illustrating a method for completing a pending online transaction request on a network device. In block 305, a contextual prompt is provided whose acknowledgement initiates collecting transaction information. The prompt may be acknowledged by Network 100, Online Location 110, User 120, Network Device 130, Transaction Database 140, Application Server 150, or Transaction Service Provider 160. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160.

FIG. 3C is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160. In block 360, collected transaction information is stored. Transaction information may be stored by Network 100, Online Location 110, User 120, Network Device 130, Transaction Database 140, Application Server 150, or Transaction Service Provider 160.

FIG. 3D is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 345, Transaction Window Interface 135 prompts for additional transaction information. This information may be provided in whole or part by Network 100, Online Location 110, User 120, Network Device 130, Transaction Database 140, Application Server 150, or Transaction Service Provider 160. This prompt is based on transaction information already collected related to a pending online transaction. In block 350, collected transaction information related to a pending online transaction is transmitted to Transaction Service Provider 160.

FIG. 3E is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160. In block 370, a contextual prompt is provided that once acknowledged cancels the transmission of the transaction information related to a pending online transaction. This prompt may be provided by Network 100, Online Location 110, User 120, Network Device 130, Transaction Database 140, Application Server 150, or Transaction Service Provider 160.

FIG. 3F is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160. In block 380, promotional information is provided in the Transaction Window Interface 135 based on collected transaction information. This promotional information may be provided by Network 100, Online Location 110, User 120, Network Device 130, Transaction Database 140, Application Server 150, or Transaction Service Provider 160. This promotional information may be an advertisement, user-generated content, a map, a piece of static or dynamic media such as a picture, video, or audio clip, specialized formatting of transaction information provided within the Transaction Window Interface 135, or other static or dynamically generated information designed to promote awareness of the information or incentivize purchase or payment actions.

FIG. 3G is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160. In block 380, promotional information is provided in the Transaction Window Interface 135 based on collected transaction information. This promotional information may be provided by Network 100, Online Location 110, User 120, Network Device 130, Transaction Database 140, Application Server 150, or Transaction Service Provider 160. This promotional information may be an advertisement, user-generated content, a map, a piece of static or dynamic media such as a picture, video, or audio clip, specialized formatting of transaction information provided within the Transaction Window Interface 135, or other static or dynamically generated information designed to promote awareness of the information or incentivize purchase or payment actions. In block 390, an online transaction is initiated related to the displayed promotional information displayed based on block 380. This transaction may be separate from a pending transaction referenced in block 350 or related to a pending transaction referenced in block 350.

FIG. 3H is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160. In block 395, it is determined whether there was a successful transmission of transaction information related to a pending online transaction to Transaction Service Provider 100. This determination may be made by Online Location 110, User 120, Network Device 130, Transaction Database 140, Application Server 150, or Transaction Service Provider 160.

FIG. 3I is a flow diagram illustrating a method for completing a pending online transaction request on a network device. As shown in block 310, information is collected from the Network 100, Online Location 110, User 120, Network Device 130, Transaction Database 140, Application Server 150, and Transaction Service Provider 160. In block 320, Application Server 150 in conjunction with the Network Device 130 provides a Transaction Window Interface 135 on the screen of Network Device 130. In block 330, Transaction Window Interface 135 displays collected transaction information related to a pending online transaction. In block 340, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 350, collected transaction information related to a pending online transaction is transmitted to Transaction Service Provider 160. In block 395, it is determined whether there was a successful transmission of transaction information related to a pending online transaction to Transaction Service Provider 100. This determination may be made by Online Location 110, User 120, Network Device 130, Transaction Database 140, Application Server 150, or Transaction Service Provider 160. In block 397, the results of the whether the transmission of transaction information related to a pending online transaction to a transaction service provider was successful is presented in Transaction Window 135.

FIG. 4A is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160.

FIG. 4B is a flow diagram illustrating a method for completing a pending online payment request on a network device. In block 305, a contextual prompt is provided whose acknowledgement initiates collecting transaction information. The prompt may be acknowledged by Network 100, Online Location 110, User 120, Network Device 130, Transaction Database 140, Application Server 150, or Transaction Service Provider 160. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160.

FIG. 4C is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 460, collected transaction information is stored. Transaction information may be stored by Network 100, Online Location 110, User 120, Network Device 130, Transaction Database 140, Application Server 150, or Transaction Service Provider 160.

FIG. 4D is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 345, Transaction Window Interface 135 prompts for additional transaction information. This information may be provided in whole or part by Network 100, Online Location 110, User 120, Network Device 130, Transaction Database 140, Application Server 150, or Transaction Service Provider 160. This prompt is based on transaction information already collected related to a pending online transaction. In block 450, collected transaction information related to a pending online transaction is transmitted to Transaction Service Provider 160.

FIG. 4E is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 470, a contextual prompt is provided that once acknowledged cancels the transmission of the transaction information related to a pending online transaction. This prompt may be provided by Network 100, Online Location 110, User 120, Network Device 130, Transaction Database 140, Application Server 150, or Transaction Service Provider 160.

FIG. 4F is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 480, promotional information is provided in the Transaction Window Interface 135 based on collected transaction information. This promotional information may be provided by Network 100, Online Location 110, User 120, Network Device 130, Transaction Database 140, Application Server 150, or Transaction Service Provider 160. This promotional information may be an advertisement, user-generated content, a map, a piece of static or dynamic media such as a picture, video, or audio clip, specialized formatting of transaction information provided within the Transaction Window Interface 135, or other static or dynamically generated information designed to promote awareness of the information or incentivize purchase or payment actions.

FIG. 4G is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 480, promotional information is provided in the Transaction Window Interface 135 based on collected transaction information. This promotional information may be provided by Network 100, Online Location 110, User 120, Network Device 130, Transaction Database 140, Application Server 150, or Transaction Service Provider 160. This promotional information may be an advertisement, user-generated content, a map, a piece of static or dynamic media such as a picture, video, or audio clip, specialized formatting of transaction information provided within the Transaction Window Interface 135, or other static or dynamically generated information designed to promote awareness of the information or incentivize purchase or payment actions. In block 490, an online transaction is initiated related to the displayed promotional information displayed based on block 480. This transaction may be separate from a pending transaction referenced in block 450 or related to a pending transaction referenced in block 450.

FIG. 4H is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 495, it is determined whether there was a successful transmission of transaction information related to a pending online transaction to Transaction Service Provider 100. This determination may be made by Online Location 110, User 120, Network Device 130, Transaction Database 140, Application Server 150, or Transaction Service Provider 160.

FIG. 4I is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 495, it is determined whether there was a successful transmission of transaction information related to a pending online transaction to Transaction Service Provider 100. This determination may be made by Online Location 110, User 120, Network Device 130, Transaction Database 140, Application Server 150, or Transaction Service Provider 160. In block 497, the results of the whether the transmission of transaction information related to a pending online transaction to a transaction service provider was successful is presented in Transaction Window 135.

FIG. 4J is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 498, it is determined whether the online payment submitted to Transaction Service Provider 135 was approved. This determination may come through an analysis of Network 100, Online Location 110, User 120, Network Device 130, Transaction Database 140, Application Server 150, or Transaction Service Provider 160.

FIG. 4K is a flow diagram illustrating a method for completing a pending online payment request on a network device. As shown in block 410, information is collected from the Network 100, Online Location 110, User 120, Network Device 130, Transaction Database 140, Application Server 150, and Transaction Service Provider 160. In block 420, Application Server 150 in conjunction with the Network Device 130 provides a Transaction Window Interface 135 on the screen of Network Device 130. In block 430, Transaction Window Interface 135 displays collected transaction information related to a pending online transaction. In block 440, Transaction Window Interface 135 prompts for additional transaction information. This information may be provided in whole or part by Network 100, Online Location 110, User 120, Network Device 130, Transaction Database 140, Application Server 150, or Transaction Service Provider 160. In block 450, collected transaction information related to a pending online transaction is transmitted to Transaction Service Provider 160. In block 498, it is determined whether the online payment submitted to Transaction Service Provider 135 was approved. This determination may come through an analysis of Network 100, Online Location 110, User 120, Network Device 130, Transaction Database 140, Application Server 150, or Transaction Service Provider 160. In block 499, the results of whether the online payment submitted to Transaction Service Provider 135 was approved is displayed in Transaction Window Interface 135.

The invention claimed is:

1. A computer implemented system and method for completing a pending online transaction request on a network device, comprising the steps of:
Collecting transaction information related to a pending online transaction;
Providing a visible transaction window interface on a network device;
Displaying collected transaction information related to a pending online transaction in a visible transaction window interface on a network device;
Collecting additional prompted transaction information related to a pending online transaction using a visible transaction window interface on a network device;
Transmitting transaction information related to a pending online transaction to a transaction services provider.

2. The method of claim 1, further comprising the step of providing a contextual prompt prior to collecting transaction information related to a pending online transaction whose acknowledgement initiates collecting transaction information related to a pending online transaction.

3. The method of claim 1, further comprising the step of storing collected transaction information.

4. The method of claim 1, wherein the step of collecting additional prompted transaction information related to a pending online transaction is further refined to basing the prompting for additional transaction information on transaction information already collected related to a pending online transaction.

5. The method of claim 1, further comprising the step of providing a contextual prompt that once acknowledged initiates the action of cancelling the transmission of transaction information related to a pending online transaction to a transaction services provider.

6. The method of claim 1, further comprising the step of displaying promotional information in the visible transaction window interface based on collected transaction information.

7. The method of claim 6, further comprising the step of initiating an online transaction related to the displayed promotional information shown in the visible transaction window interface.

8. The method of claim 1, further comprising the step of determining whether the transmission of transaction information related to a pending online transaction to a transaction services provider was successful.

9. The method of claim 8, further comprising the step of displaying the results of the determination as to whether the transmission of transaction information related to a pending online transaction to a transaction services provider was successful in a transaction window interface.

10. A computer implemented system and method for completing a pending online payment request on a network device, comprising the steps of:
Collecting transaction information related to a pending online payment;
Providing a visible transaction window interface on a network device;
Displaying collected transaction information related to a pending online payment in a visible transaction window interface on a network device;
Collecting additional prompted transaction information related to a pending online payment using a visible transaction window interface on a network device;
Transmitting transaction information related to a pending online payment to a transaction services provider.

11. The method of claim 10, further comprising the step of providing a contextual prompt prior to collecting transaction information related to a pending online payment whose acknowledgement initiates collecting transaction information related to a pending online payment.

12. The method of claim 10, further comprising the step of storing collected transaction information.

13. The method of claim 10, wherein the step of collecting additional prompted transaction information related to a pending online payment is further refined to basing the prompting for additional transaction information on transaction information already collected related to a pending online payment.

14. The method of claim 10, further comprising the step of providing a contextual prompt that once acknowledged initiates the action of cancelling the transmission of transaction information related to a pending online payment to a transaction services provider.

15. The method of claim 10, further comprising the step of displaying promotional information in the visible transaction window interface based on collected transaction information.

16. The method of claim 15, further comprising the step of initiating an online transaction related to the displayed promotional information shown in the visible transaction window interface.

17. The method of claim 16, further comprising the step of determining whether the transmission of transaction information related to a pending online payment to a transaction services provider was successful.

18. The method of claim 17, further comprising the step of displaying the results of the determination as to whether the transmission of transaction information related to a pending online payment to a transaction services provider was successful in a transaction window interface.

19. The method of claim 10, further comprising the step of determining whether the transmission of transaction information related to a pending online payment to a transaction services provider resulted in successful approval of that online payment.

20. The method of claim 19, further comprising the step of displaying the results of the determination as to whether the transmission of transaction information related to a pending online payment to a transaction services provider resulted in successful approval of that online payment in a transaction window interface.
